(19) United States
(12) Patent Application Publication
(10) Pub. No.: US 2025/0245639 A1
(43) Pub. Date: Jul. 31, 2025

(54) COMPUTER SYSTEMS AND METHODS FOR COMPLIANT COLLECTION OF PREMIUMS OWED TO A HEALTHCARE SERVICES PAYER VIA AUTOMATED CLEARING HOUSE (ACH) TRANSFERS

(71) Applicant: The PNC Financial Services Group, Inc., Pittsburgh, PA (US)

(72) Inventor: R. Keith Henry, Port Saint Lucie, FL (US)

(21) Appl. No.: 19/039,130

(22) Filed: Jan. 28, 2025

Related U.S. Application Data
(60) Provisional application No. 63/627,149, filed on Jan. 31, 2024.

(51) Int. Cl. G06Q 20/10; G06Q 20/02; G06Q 20/40

(52) U.S. Cl. CPC G06Q 20/102; G06Q 20/023; G06Q 20/401

(57) ABSTRACT

Methods and systems for automating compliant collection of premiums are disclosed. The premiums can be collected by a financial institution. The premiums can be owed to a healthcare services payer from subscribers to the healthcare services payer.

### CROSS-REFERENCE TO RELATED APPLICATIONS

The present application claims the benefit of and priority under 35 U.S.C. § 119(e) to U.S. Provisional Patent Application No. 63/627,149, filed on Jan. 31, 2024, the disclosure of which is hereby incorporated by reference in its entirety herein.

### BACKGROUND

Electronic funds transfer (EFT) allows the direct deposit of money electronically without requiring the use of paper checks. The Automated Clearing House (ACH) is the primary system entities use for EFT. Entities that participate in the ACH system follow operating rules developed by NACHA, originally the National Automated Clearinghouse Association (NACHA). Among other rules, compliance with NACHA requires any transmission of banking information to be encrypted using commercially reasonable encryption technology if transmitted via an unsecured network, such as the Internet. NACHA rules further require certain entities (e.g. non-financial institution originators, third-party service providers, and third-party senders) to protect deposit account information by rendering it unreadable when it is stored at rest.

### SUMMARY

In one general aspect, the present invention is directed to a computer-implemented method and computer system for automating collection of premiums by a financial institution owed to a healthcare services payer from subscribers to the healthcare services payer. The healthcare services payer manages a healthcare services payer database, and the financial institution manages a separate database, which is compliant with NACHA rules, i.e. a NACHA-compliant database. The financial institution securely receives subscriber account data for subscribers to the healthcare services payer. The subscriber account data can include sensitive Automated Clearing House (ACH) data for each subscriber; the data can be encrypted. Upon receiving the subscriber account data, an account verification system of the financial institution can verify the subscriber account data. Each subscriber can by identified as a verified subscriber or an unverified subscriber based on the verification. For each verified subscriber, the sensitive ACH data can be stored in the financial institution's compliant database. For each unverified subscriber, the account verification system can transmit a notification to the healthcare services payer indicating the status of the subscriber as unverified. The financial institution can routinely implement transfers of the premiums owed by the verified subscribers to the healthcare services payer by ACH transfer for compliant collection of those premiums.

As an example, a healthcare insurer can provide a bank with a list of its subscribers, along with subscriber account data for facilitating ACH transfers. The bank can verify the subscriber account data and store the data in a compliant database. The healthcare insurer can remove the corresponding data. Thereafter, when a premium is owned to the healthcare insurer from one or more of the subscribers, the bank can initiate one or more ACH transfer(s).

In various instances, upon verifying the account information for the subscribers, the financial institution can transmit instructions to the healthcare services payer to remove the sensitive ACH data in its database. Thereafter, the healthcare services payer can remove the sensitive ACH data. For example, referring again to the foregoing example, the financial institution care store the sensitive ACH data and the healthcare insurer can remove the sensitive ACH data.

Systems according to the present invention provide significant technical benefits. For example, the bank provides a secure system for transferring data, information, and/or payments from the subscribers to the healthcare insurer to ensure compliant collections. In such instances, the healthcare insurer mitigates exposure and/or avoids the risks and/or costs associated with managing and storing certain sensitive information, such as the ACH data of its subscribers. These and other benefits that can be realized through embodiments of the present invention will be apparent from the description that follows.

### FIGURES

Various embodiments of the present invention are described herein by way of example in connection with the following figures.

FIG. 1 is a diagram of a system for transferring payments from subscribers to a healthcare services payer via an ACH operator, according to various embodiments of the present disclosure.

FIG. 2 is a diagram of a system, including various computer systems, for initiating ACH transfers between financial institutions to automate the payment of premiums from subscribers to the healthcare services payer of FIG. 1, according to various embodiments of the present invention.

FIG. 3 is a flow chart illustrating a process flow of the system of FIG. 2, according to various embodiments of the present invention.

### DESCRIPTION

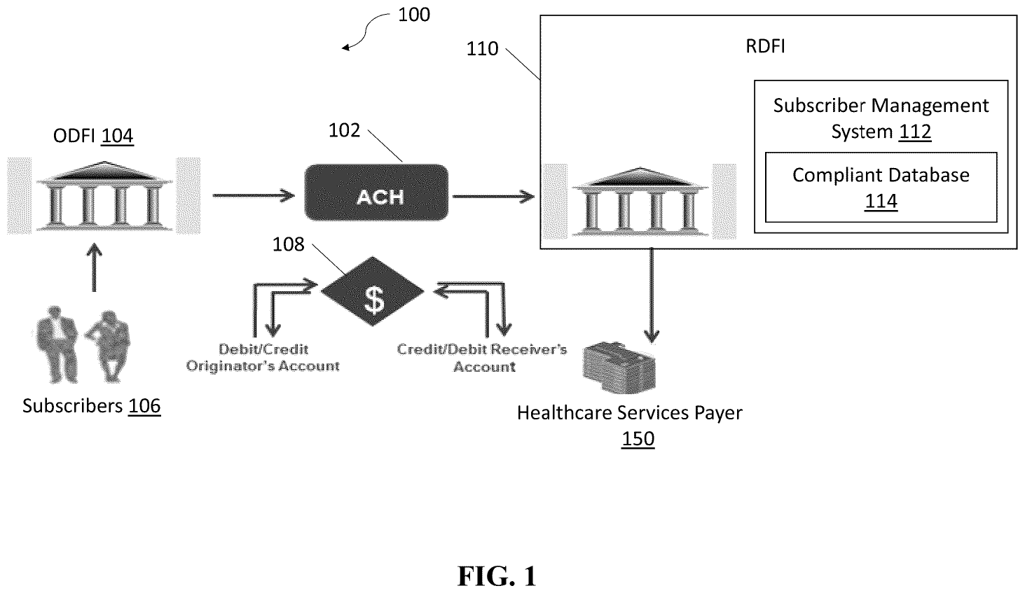

Referring primarily to FIG. 1, an ACH system 100 is shown. The ACH system 100 includes a number of participants including an ACH operator 102, an originating depository financial institution (ODFI) 104, a receiving depository financial institution (RDFI) 110, a healthcare services payer 150, and subscribers 106.

The ACH operator 102 is the intermediary between the ODFI 104 and the RDFI 110. The ACH operator 102 can be the Federal Reserve Bank or the Electronic Payments Network, for example. A financial institution, such as the ODFI 104 and the RDFI 110, for example, are banks that facilitate financial transactions.

Healthcare services payers, such as the healthcare services payer 150, can pay for healthcare services, or a predetermined amount of those services, on behalf of subscribers to a plan managed by the healthcare services payer. A healthcare services payer 150 can be an insurance company, for example.

The subscribers 106 are members of a plan managed by the healthcare services payer 150. Subscribers can be individuals. In the health insurance context, a subscriber can subscribed to a retail plan or, in certain instances, a group plan managed by the health services payer 150.

The subscribers 106 are payees to the healthcare services payer 150. The subscribers 106 authorize the healthcare services payer 150 to transact against their accounts. For example, the subscribers 106 authorize the healthcare services payer 150 to collect premiums for the plan(s) to which each subscribers has actively subscribed to. In such instances, the premium payment 108 from the bank account of each subscriber 106 can be debited and the bank account of the healthcare services payer 150 can be credited with the premium payment 108 via the ACH system 100.

For illustrative purposes, the ODFI 104 is the sole financial institution associated with the subscribers 106 in FIG. 1. In other instances, one or more of the subscribers 106 can be associated with a different financial institution that interacts with the ACH operator 102 to facilitate ACH transfers to the healthcare services payer 150. For example, one or more of the subscribers can maintain a bank account at a financial institution separate and distinct from the ODFI 104. The reader will appreciate that the multiple subscribers and/or multiple originating depository financial institutions are contemplated and encompassed by the disclosure.

As further described herein, the RDFI 110 includes a subscriber management system 112, which is configured to securely receive and store subscriber account data in a compliant database 114 for the subscribers 106 to the healthcare services payer 150.

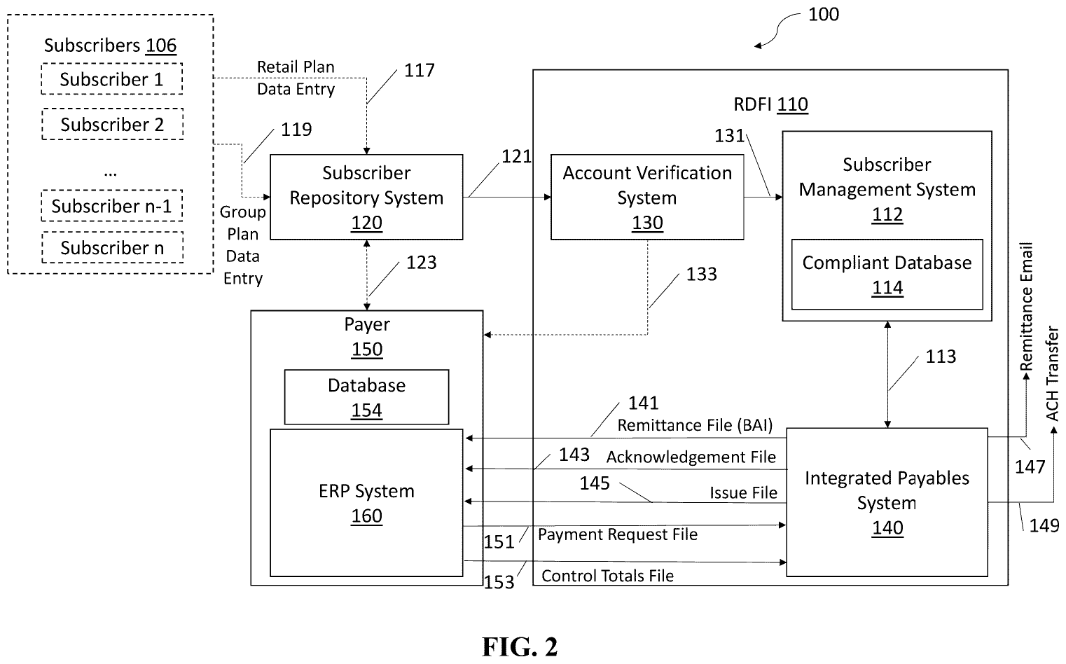

Various entities from the system 100 are further depicted in FIG. 2 and certain entities from the system 100 are excluded from FIG. 2 for the sake of clarity. For example, the subscribers 106, the healthcare services payer 150, and the RDFI 110 are shown in FIG. 2. The reader will appreciate that an ACH transfer between the subscribers 106 and the healthcare services payer 150 further relies on at least one ACH operator 102 and ODFI 104 (see FIG. 1).

The system 100 in FIG. 2 is for automating collection of premiums owed to the healthcare services payer 150 from subscribers 106 to the healthcare services payer 150 by the RDFI 110. The system 100 comprises a computer network with multiple inter-networked computer systems, e.g., computers systems for the subscriber repository system 120, the RDFI 110, the payer 150, and the various subscribers 106. Each of the computer systems may comprise one or more processors and associated computer memory storing instructions such that the various computer systems, through software stored in the memory, are configured to receive and store subscriber account data and initiate ACH transfers of the premium owned by the subscribers 106 to the healthcare services payer 150. For example, the RDFI 110 can include at least one computer system with a processor and a memory, along with a compliant database (e.g. database 114), and the healthcare services payer 150 can include at least one computer system, with a processor and a memory, along with a database 154 that stores different information than the database 154 as described herein. The various computer systems may be interconnected via an electronic data network(s), such as the Internet, a LAN(s), a WAN(s), etc., with wired and/or wireless communication links.

The RDFI 110 includes the subscriber management system 112, an account verification system 130, and an integrated payables system 140. The subscriber management system 112 is communicatively coupled to the account verification system 130 via a communication protocol 131 and to the integrated payables system 140 via the communications pathway 113.

In certain instances, the RDFI 110 can further include a subscriber repository system 120, which is configured to receive the subscriber account data. The subscriber repository system 120 can be an in-house computer system of the RDFI 110, e.g., within the network firewalls/perimeter of the RDFI 110. The reader will appreciate that various components of an in-house computer system can be remote to the physical location or address of the RDFI 110, such as remote servers, for example.

In other instances, the subscriber repository system 120 can be external to the RDFI 110, e.g., outside of the network firewalls of the RDFI 110. For example, instead of an in-house platform, a third party can manage the subscriber repository system 120 and computer system thereof.

In various instances, the healthcare services payer 150 can act as an information conduit between the subscribers 106 and the subscriber repository system 120. For example, the healthcare services payer 150 can transmit information about the subscribers 106 from the database 154 to the subscriber repository system 120 via communications pathway 123. In other instances, the healthcare services payer 150 can direct its subscribers 106 to the subscriber repository system 120 to input their subscriber account data directly thereto, as depicted in FIG. 2. In such instances, the subscriber account data bypasses the healthcare services payer 150 and is not stored in the database 154 thereof.

The subscriber repository system 120 is preferably NACHA-compliant. For example, data in the subscriber repository system 120 can be encrypted; commercially reasonable encryption technology can be utilized for all transmission of data to and/or from the subscriber repository system 120 via an unsecured network (e.g. the Internet). Moreover, data stored in the subscriber repository system 120 can be unreadable when stored at rest.

The subscriber repository system 120 is configured for ACH data entry for group plan subscribers via input communications pathway 119 and/or retail plan subscribers via input communications pathway 117. Subscriber account data received by the subscriber repository system 120 includes sensitive ACH data for facilitating ACH transfer(s) from the subscribers 106 to the healthcare services payer 150. Sensitive ACH data includes subscriber identification information and account information for each subscriber. Account information for each subscriber includes a routing number and an account number for an account associated with each subscriber 106, such as a bank account at the ODFI 104 (FIG. 1). The account information can further include identification of the account as a business account or a personal account.

In various instances, the data received in the subscriber repository system 120 can be transmitted to the account verification system 130 via a communications pathway 121, which can be an application programming interface (API) or a data upload, for example. The account verification system 130 includes a computer system configured to verify the subscriber account data received by the subscriber repository system 120. Based on the verification, the subscriber verification system 130 is configured to classify each subscriber entered into the subscriber repository system 120 as either a verified subscriber or an unverified subscriber.

The account verification system 130 can include a machine learning model comprising a neural network. In various instances, verification of the subscriber account data by the account verification system 130 is a multifaceted process via the machine learning model and neural network(s) thereof. For example, verification can require verification of both (A) key data points associated with the bank account information for each subscriber using a first neural network and (B) the identity of the subscriber using a second neural network. The neural networks can be trained, through machine learning, to (A) verify the key data points for the verification and (B) verify the identity of the subscriber. The neural networks can be trained with historical positive and negative subscriber account training samples to learn to make the verifications.

Key data point verification comprises confirmation that the bank account exists. Key data point verification can further comprise confirmation of the status and/or standing of the bank account (e.g. in good standing), maturity of the bank account, and/or other key data points regarding known U.S. bank accounts, for example. Bank account verification can further include an authentication component. For example, the account verification system 130 can be further configured to compare inquiry data to account signature data to authenticate the bank account. Bank account verification is optimized to mitigate social engineering scams in various instances.

Additionally or alternatively, the account verification system 130 can be configured to verify the identity of the subscribers 106. For example, the account verification system 130 is configured to confirm the identity of individuals through the delivery of summary and/or detailed inquiry responses. Identity verification can further include an Email and Social Intelligence (ESI) component, which is configured to confirm email account existence, ownership, age, activity, associated social media account, reported fraud, and other information available online and associated with the subscriber's identity. For example, verifying the identity of a subscriber 106 can include cross-checking the subscriber account data input to the subscriber repository system 120 with ESI data by the account verification system 130.

The RDFI 110 further includes the subscriber management system 112 communicatively coupled to the account verification system 130 via the communications pathway 131. In various instances, the subscriber management system 112 is configured to receive the ACH data from the account verification system 130 via a secure data upload, such as by an API using an SSL connection or TLS encryption protocol like HTTPS, for example. The subscriber management system 112 comprises a computer system comprising a memory configured to manage the subscriber account data uploaded thereto. For example, the subscriber management system 112 includes the compliant database 114 for storing the ACH data for each verified subscriber in an electronic format. The database 114 is compliant with the rules governing ACH transfers, e.g. NACHA rules, and thus, constitutes a “compliant database.” In various aspects, the ACH data is stored in the compliant database in an electronic format in which the data is unreadable at rest. The ACH data in the compliant database 114 can be encrypted with at least 128-bit encryption protocols and, in other instances, at least 256-bit encryption. For example, 128-bit or 256-bit advanced encryption system (AES), SSL or RSA encryption could be employed for the compliant database 114.

The healthcare services payer 150 further includes a healthcare services payer database 154. The database 154 stores different information than the compliant database 114. For example, the account verification system 130 can provide clearance and/or instructions to the healthcare services payer 150 via communications pathway 133 to remove sensitive ACH data from the healthcare services payer database 154. Thereafter, the healthcare services payer 150 can remove the sensitive ACH data from the healthcare services payer database 154. In such instances, the database 154 comprises different information than the compliant database 114. Moreover, while the compliant database 114 is compliant with NACHA rules, for example, NACHA may not regulate and/or require the same standard of security for the database 154.

In various instances, the account verification system 130, upon verifying the subscriber account data, can transmit a message via communications pathway 133 to the healthcare services payer 150 notifying the healthcare services payer 150 that one or more particular subscribers are unverified. In such instances, the healthcare services payer 150 may request additional information from the subscriber 106 regarding the financial security of the subscriber 106 and/or alternative payment schemes, for example.

The RDFI 110 is configured to initiate an ACH transfer of the premium owed by the verified subscriber(s) 106 to the healthcare services payer 150. For example, the RDFI 110 can routinely transfer premiums owned by the verified subscribers 106 to the healthcare services payer 150 by an ACH transfer. For example, the RDFI 110 can routinely transfer the premium at a predefined interval, such as annually, semi-annually, quarterly, bi-monthly, monthly, and/or weekly, for example.

In various instances, the integrated payables system 140 is communicatively coupled to the subscriber management system 112 via a communications pathway 113. The integrated payables system 140 can access subscriber account data stored in the subscriber management system 112 and transmit an ACH file to an ACH operator via pathway 149 to initiate an ACH transfer. The ACH file includes subscriber identification, payment amount, and remittance information, for example, for collection of the premium owed by the verified subscriber(s) 106.

In various instances, the integrated payables system 140 is further configured to transmit a remittance email to each verified subscriber 106 confirming the ACH transfer of the premium to the healthcare services payer 150. The integrated payables system 140 enables the RDFI 110 to send instructions for initiating multiple payment types in a single consolidated file. Via the integrated payables system 140, the RDFI 110 can transmit all of the payment instructions in a single file (i.e. a batch payment) and receive back acknowledgements, confirmation, and information reporting online and/or via secure file transmission.

The healthcare services payer 150 further includes an Enterprise Resource Planning (ERP) system 160. The ERP system 160 comprises a computer system; the ERP system is configured to generate a file of payment instructions as a payment request file. In various aspects, the payment request file is in an industry standard format, such as 820 format, for example. The payment request file can be transmitted to the integrated payables computer system 140 via the communications pathway 151, for example. The ERP system can further transmit the Controls Total File to the integrated payables system 140 via communications pathway 153. For example, the ERP system 160 can transmit a batch payment request to the RDFI 110 for collection of premiums owed by verified subscriber(s) to the healthcare services payer 150. Thereafter, the integrated payables system 140 can transmit an issue file via communications pathway 145, an acknowledgement file via communications pathway 143, and a remittance file via communications pathway 141, for example. The acknowledgement file can include an item count and a payment amount for each ACH transfer. The remittance data transmitted via communications pathway 141 can comprise a standardized file format for performing electronic cash management balance reporting, such as BAI format, for example.

The electronic messages described herein, such as and including electronic messages sent between the integrated payables system 140 and the healthcare services payer 150, may be any suitable type of electronic message that can be sent over a computer network, can include packets, frames, datagrams, etc., and can be sent via APIs. In that connection, the various computer components described herein can communicate along the various communication pathways using any suitable network protocol, such as the Transmission Control Protocol (TCP), Internet Protocol (IP), Hypertext Transfer Protocol (HTTP), File Transfer Protocol (FTTP), or any other suitable network protocol.

The subscriber management system 112, account verification system 130, integrated payables 140 and/or the subscriber repository system 120 can be implemented with one server or a network of servers. Each such server may comprise one or more processor cores and computer memories for storing software executed by the processor core(s). The program instructions (e.g., software) could be stored in a computer memory that is accessible by the processor cores, such as RAM, ROM, processor registers or processor cache, for example. Data may be shared between the various systems using suitable data links, such as data buses (preferably high-speed data buses) or network links (e.g., Ethernet).

The software for the various computer systems described herein and other computer functions described herein may be implemented in computer software using any suitable computer programming language such as .NET, C, C++, Python, and using conventional, functional, or object-oriented techniques. Programming languages for computer software and other computer-implemented instructions may be translated into machine language by a compiler or an assembler before execution and/or may be translated directly at run time by an interpreter. Examples of assembly languages include ARM, MIPS, and x86; examples of high level languages include Ada, BASIC, C, C++, C#, COBOL, Fortran, Java, Lisp, Pascal, Object Pascal, Haskell, ML; and examples of scripting languages include Bourne script, JavaScript, Python, Ruby, Lua, PHP, and Perl.

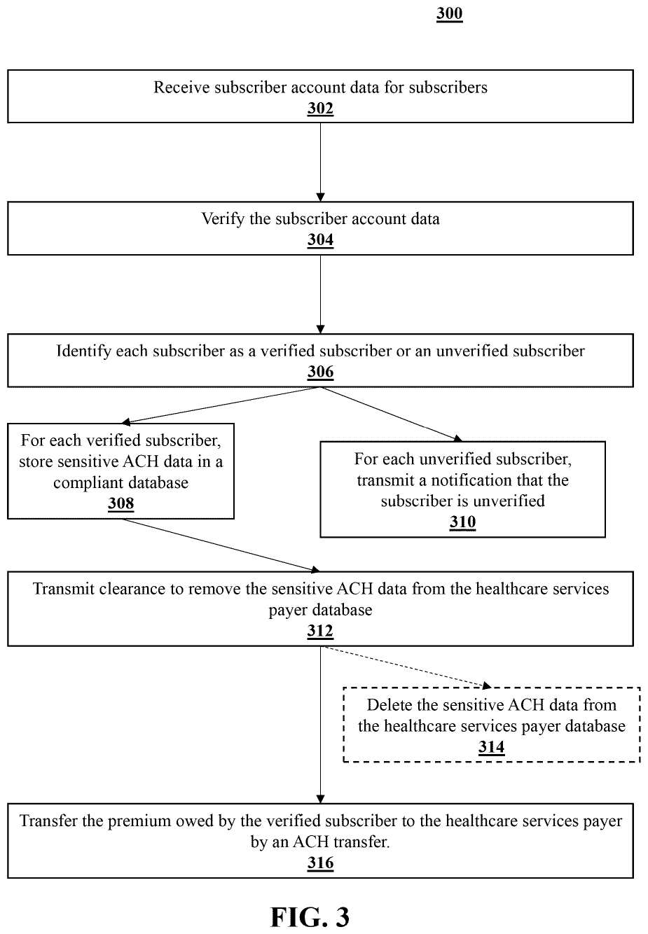

FIG. 3 illustrates a process 300 according to various embodiments of the present invention. At step 302, subscriber account data is received. The subscriber account data can be from group plan ACH data entry or retail plan ACH data entry, for example. A financial institution and/or third party operating on behalf of the financial institution can provide the tool(s), such as an web portal, for example, for receiving the subscriber account data. The subscriber account data can be received by the subscriber repository system 120, for example.

At step 304, the subscriber account data is verified by the financial institution. For example, the account verification system 130 is configured to verify the subscriber account data. Verification can include, for example, bank account verification and identity verification, as further described herein. At step 306, each subscriber can be classified as either a verified subscriber or an unverified subscriber based on the output from the account verification system 130. For each unverified subscriber, the process 300 proceeds to step 310, in which a notification that the subscriber is unverified is transmitted. For example, the notification can be transmitted from the account verification system 130 to a payer, such as the healthcare services payer 150, for example. For unverified subscribers, premiums cannot be collected by ACH transfer by the compliant collections systems disclosed herein.

For each verified subscriber, the process 300 proceeds to step 308, in which the sensitive ACH data received by the subscriber repository system 120 is stored in a compliant database. Moreover, at step 312, clearance to remove the corresponding data can be transmitted to the payer. For example, the financial institution can instruct the payer to remove the sensitive ACH data from its database. In certain instances, the payer can remove the sensitive ACH data from its database at step 314.

At step 316, an ACH transfer can be implemented. For example, a premium owned by a verified subscriber to the payer can be paid by ACH transfer. Such ACH transfers can be regular and/or routine. For example, the transfers can occur at predefined intervals based on the payment structure agreed to by the verified subscriber and the payer. In other instances, step 316 can consist of a single ACH transfer. In certain instances, the ACH transfer at step 316 can be a batch transfer for multiple subscribers and/or multiple plans.

In various embodiments, the process 300 may be repeated whenever a subscriber signs up for a plan. In other embodiments, upon completion of step 310, an unverified subscriber can provide supplemental and/or updated information at step 302 and the process may be repeated.

In various embodiments, therefore, the present disclosure is directed to a method and system for automating compliant collection of premiums by a financial institution owed to a healthcare services payer from subscribers to the healthcare services payer. The method comprises receiving, by a computer system of the financial institution, via an electronic data network, subscriber account data for subscribers to the healthcare services payer, wherein the subscriber account data comprise sensitive Automated Clearing House (ACH) data for each subscriber; upon receiving subscriber account data for subscribers to the healthcare services provider, verifying, by a computerized account verification system of the computer system of the financial institution, the subscriber account data; and upon verifying the subscriber account data, identifying, by the computerized account verification system, each subscriber as one of a verified subscriber and an unverified subscriber, such that at least one subscriber is identified as a verified subscriber and at least one subscriber is identified as an unverified subscriber. The method further includes, for each unverified subscriber, transmitting, via the electronic data network, by the computerized account verification system to the healthcare services payer, an electronic notification that the subscriber is unverified; and, for each verified subscriber: storing, encryptedly, by the financial institution, the sensitive ACH data in a compliant database of the computer system of the financial institution; transmitting, by the financial institution to the healthcare services payer, via the electronic data network, clearance to remove the sensitive ACH data from the payer database; and routinely transferring, by the financial institution to the healthcare services payer, the premium owed by the verified subscriber to the healthcare services payer by an ACH transfer.

Additionally, in various embodiments, the compliant database is separate from the payer database, wherein the sensitive ACH data are stored in the compliant database in compliance with NACHA rules, and wherein the method further comprises removing, by the healthcare services payer, the sensitive ACH data from the payer database.

Additionally or alternatively, the foregoing method further comprises routinely transferring the premium owned by the verified subscriber to the healthcare services payer comprises automatically paying the premium at a predefined interval.

Additionally or alternatively, the sensitive ACH data comprises subscriber identification and account information for each subscriber, wherein the account information for each subscriber further comprises a routing number and an account number for an account, and wherein the account information further comprises identification of the account as one of a business account and a personal account.

Additionally or alternatively, the foregoing method further comprises storing the sensitive ACH data comprises encrypting the sensitive ACH data with at least a 128-bit encryption protocol.

Additionally or alternatively, the foregoing financial institution further comprises a subscriber management computer system comprising a memory, wherein storing the sensitive ACH data in an electronic format comprises storing the compliant database in the memory of the subscriber management computer system, and wherein the sensitive ACH data is stored in a format that is non-human-readable at rest.

Additionally or alternatively, the foregoing method(s) further comprise receiving, by the subscriber management computer system, the sensitive ACH data from the computerized account verification system via a secure application programming interface.

Additionally or alternatively, the foregoing method(s) further comprise an integrated payables computer system, and the method further comprises transmitting, by the integrated payables computer system, an ACH file to an ACH operator, wherein the ACH file comprises subscriber identification, payment amount, and remittance information for collection of a premium owed by verified subscribers.

Additionally or alternatively, the foregoing method(s) further comprise transmitting, by the integrated payables computer system, a remittance email to each verified subscriber confirming the ACH transfer of the premium to the healthcare services payer.

Additionally or alternatively, the foregoing healthcare services payer further comprises an enterprise resource planning computer system, and the method further comprises receiving, from the enterprise resource planning computer system, a batch request for collection of premiums from multiple verified subscribers.

Additionally or alternatively, the forgoing method further comprises transmitting, by the integrated payables computer system to the enterprise resource planning computer system, an acknowledgement file, wherein the acknowledgement file comprises an item count and a payment amount for each ACH transfer in the batch request.

Additionally or alternatively, the foregoing method(s) further comprise, transmitting by the integrated payables computer system to the enterprise resource planning computer system, remittance data in a standardized file format for performing electronic cash management balance reporting.

Additionally or alternatively, the financial institution further comprises an encrypted subscriber repository computer system configured to receive the subscriber account data, the method further comprising transmitting the subscriber account data from the encrypted subscriber repository computer system to the computerized account verification system via an application programming interface.

Additionally or alternatively, the sensitive ACH data comprises identification and account information for each subscriber, and verifying the subscriber account data further comprises a multifaceted verification comprising: verifying, by the computerized account verification system of the financial institution, key data points associated with the account information for each subscriber; and verifying, by the computerized account verification system of the financial institution, the identity of the subscriber associated with the identification of each subscriber.

Additionally or alternatively, verifying key data points associated with the account information for each subscriber comprises confirming, by the computerized account verification system of the financial institution, the existence, status, and maturity of a bank account.

Additionally or alternatively, the multifaceted verification further comprises comparing, by the computerized account verification system of the financial institution, inquiry data to account signature data to authenticate the bank account.

Additionally or alternatively, verifying the identity of the subscriber associated with the identification for each subscriber comprises confirming, by the computerized account verification system of the financial institution, email account existence for the subscriber.

Additionally or alternatively, verifying the identity of the subscriber associated with the identification for each subscriber comprises cross-checking, by the computerized account verification system of the financial institution, the identification with social intelligence data comprising at least one of ownership, age, activities, social media accounts, and fraud reports.

In various embodiments, the present disclosure is directed to a computer system for automating collection of premiums by a financial institution owed to a healthcare services payer from subscribers to the healthcare services payer, the healthcare services payer comprising a payer database, and the computer system comprising: a subscriber repository platform; an account verification platform comprising a machine learning model comprising a neural network; a subscriber management platform comprising a compliant database; an integrated payables platform; one or more processors; and a memory storing instructions such that the computer system, through software stored in the memory, is configured to: receive subscriber account data for subscribers, via an electronic data network, at the subscriber repository platform, wherein the subscriber account data comprise sensitive Automated Clearing House (ACH) data for each subscriber; verify, by the machine learning model of the account verification platform, the subscriber account data for each subscriber such that at least one subscriber is classified as a verified subscriber and at least one subscriber is classified as an unverified subscriber; store the sensitive ACH data for each verified subscriber in an electronic format in the compliant database of the subscriber management platform, wherein the electronic format comprises an encrypted format; transmit, via an electronic data network, electronic instructions from the integrated payables platform to the healthcare services payer to remove the sensitive ACH data from the payer database; and transmit, via an electronic data network, an ACH file from the integrated payables platform to an ACH operator to initiate a transfer of the premium owed by the verified subscriber to the healthcare services payer.

Additionally, in various embodiments, the financial institution comprises a first computer network comprising a first memory, wherein the compliant database is stored in the first memory, wherein the healthcare services payer comprises a second computer network comprising a second memory, wherein the payer database is stored in the second memory, and wherein the payer database comprises different information than the compliant database.

Though various methods and computer systems discloser herein refer to a healthcare services payer, however, these methods and computer systems are applicable to other payers, as well. The compliant collections systems disclosed herein can be utilized by various service providers in different circumstances for the compliant collection of premiums by a financial institution at regular intervals.

The various computer systems described herein may comprise one or more processors and one or more data storage or computer memory units. The memory, which may comprise primary (memory directly accessible by the processor, such as RAM, processor registers and/or processor cache) and/or secondary (memory not directly accessible by the processor, such as ROM, flash, HDD, etc.) data storage, stores computer instruction or software to be executed by the processor(s). In particular, the memory may store the software for the various software modules and tools described herein. When the processor(s) executes the software, the processor(s) perform the corresponding functions described above. The processor(s) may include single or multicore CPUs, for example. The processors(s) may also comprise heterogeneous multicore processor(s) that include, for example, CPU, GPU and/or DSP cores. The software code for the tools and modules may be written suitable programming languages as described above.

Having thus described several aspects and embodiments of the technology of this application, it is to be appreciated that various alterations, modifications, and improvements will readily occur to those of ordinary skill in the art. Such alterations, modifications, and improvements are intended to be within the scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

What is claimed is:

1. A method for automating collection of premiums by a financial institution owed to a healthcare services payer from subscribers to the healthcare services payer, wherein the healthcare services payer manages a payer database, the method comprising:
receiving, by a computer system of the financial institution, via an electronic data network, subscriber account data for subscribers to the healthcare services payer, wherein the subscriber account data comprise sensitive Automated Clearing House (ACH) data for each subscriber;
upon receiving subscriber account data for subscribers to the healthcare services provider, verifying, by a computerized account verification system of the computer system of the financial institution, the subscriber account data;
upon verifying the subscriber account data, identifying, by the computerized account verification system, each subscriber as one of a verified subscriber and an unverified subscriber, such that at least one subscriber is identified as a verified subscriber and at least one subscriber is identified as an unverified subscriber;
for each unverified subscriber, transmitting, via the electronic data network, by the computerized account verification system to the healthcare services payer, an electronic notification that the subscriber is unverified; and
for each verified subscriber:
storing, encryptedly, by the financial institution, the sensitive ACH data in a compliant database of the computer system of the financial institution;
transmitting, by the financial institution to the healthcare services payer, via the electronic data network, clearance to remove the sensitive ACH data from the payer database; and
routinely transferring, by the financial institution to the healthcare services payer, the premium owed by the verified subscriber to the healthcare services payer by an ACH transfer.

2. The method of claim 1, wherein the compliant database is separate from the payer database, wherein the sensitive ACH data are stored in the compliant database in compliance with NACHA rules, and wherein the method further comprises removing, by the healthcare services payer, the sensitive ACH data from the payer database.

3. The method of claim 1, wherein routinely transferring the premium owned by the verified subscriber to the healthcare services payer comprises automatically paying the premium at a predefined interval.

4. The method of claim 1, wherein the sensitive ACH data comprises subscriber identification and account information for each subscriber, wherein the account information for each subscriber further comprises a routing number and an account number for an account, and wherein the account information further comprises identification of the account as one of a business account and a personal account.

5. The method of claim 1, wherein storing the sensitive ACH data comprises encrypting the sensitive ACH data with at least a 128-bit encryption protocol.

6. The method of claim 1, wherein the financial institution further comprises a subscriber management computer system comprising a memory, wherein storing the sensitive ACH data in an electronic format comprises storing the compliant database in the memory of the subscriber management computer system, and wherein the sensitive ACH data is stored in a format that is non-human-readable at rest.

7. The method of claim 6, further comprising receiving, by the subscriber management computer system, the sensitive ACH data from the computerized account verification system via a secure application programming interface.

8. The method of claim 7, wherein the financial institution further comprises an integrated payables computer system, and the method further comprises transmitting, by the integrated payables computer system, an ACH file to an ACH operator, wherein the ACH file comprises subscriber identification, payment amount, and remittance information for collection of a premium owed by verified subscribers.

9. The method of claim 8, further comprising transmitting, by the integrated payables computer system, a remittance email to each verified subscriber confirming the ACH transfer of the premium to the healthcare services payer.

10. The method of claim 8, wherein the healthcare services payer further comprises an enterprise resource planning computer system, and the method further comprises receiving, from the enterprise resource planning computer system, a batch request for collection of premiums from multiple verified subscribers.

11. The method of claim 10, further comprising, transmitting, by the integrated payables computer system to the enterprise resource planning computer system, an acknowledgement file, wherein the acknowledgement file comprises an item count and a payment amount for each ACH transfer in the batch request.

12. The method of claim 10, further comprising, transmitting by the integrated payables computer system to the enterprise resource planning computer system, remittance data in a standardized file format for performing electronic cash management balance reporting.

13. The method of claim 10, wherein the financial institution further comprises an encrypted subscriber repository computer system configured to receive the subscriber account data, the method further comprising transmitting the subscriber account data from the encrypted subscriber repository computer system to the computerized account verification system via an application programming interface.

14. The method of claim 1, wherein the sensitive ACH data comprises identification and account information for each subscriber, and wherein verifying the subscriber account data comprises a multifaceted verification comprising:
verifying, by the computerized account verification system of the financial institution, key data points associated with the account information for each subscriber; and
verifying, by the computerized account verification system of the financial institution, the identity of the subscriber associated with the identification of each subscriber.

15. The method of claim 14, wherein verifying key data points associated with the account information for each subscriber comprises confirming, by the computerized account verification system of the financial institution, the existence, status, and maturity of a bank account.

16. The method of claim 15, wherein the multifaceted verification further comprises comparing, by the computerized account verification system of the financial institution, inquiry data to account signature data to authenticate the bank account.

17. The method of claim 14, wherein verifying the identity of the subscriber associated with the identification for each subscriber comprises confirming, by the computerized account verification system of the financial institution, email account existence for the subscriber.

18. The method of claim 17, wherein verifying the identity of the subscriber associated with the identification for each subscriber comprises cross-checking, by the computerized account verification system of the financial institution, the identification with social intelligence data comprising at least one of ownership, age, activities, social media accounts, and fraud reports.

19. A computer system for automating collection of premiums by a financial institution owed to a healthcare services payer from subscribers to the healthcare services payer, the healthcare services payer comprising a payer database, and the computer system comprising:
a subscriber repository platform;
an account verification platform comprising a machine learning model comprising a neural network;
a subscriber management platform comprising a compliant database;
an integrated payables platform;
one or more processors; and
a memory storing instructions such that the computer system, through software stored in the memory, is configured to:
receive subscriber account data for subscribers, via an electronic data network, at the subscriber repository platform, wherein the subscriber account data comprise sensitive Automated Clearing House (ACH) data for each subscriber;
verify, by the machine learning model of the account verification platform, the subscriber account data for each subscriber such that at least one subscriber is classified as a verified subscriber and at least one subscriber is classified as an unverified subscriber;
store the sensitive ACH data for each verified subscriber in an electronic format in the compliant database of the subscriber management platform, wherein the electronic format comprises an encrypted format;
transmit, via an electronic data network, electronic instructions from the integrated payables platform to the healthcare services payer to remove the sensitive ACH data from the payer database; and
transmit, via an electronic data network, an ACH file from the integrated payables platform to an ACH operator to initiate a transfer of the premium owed by the verified subscriber to the healthcare services payer.

20. The computer system of claim 19, wherein the financial institution comprises a first computer network comprising a first memory, wherein the compliant database is stored in the first memory, wherein the healthcare services payer comprises a second computer network comprising a second memory, wherein the payer database is stored in the second memory, and wherein the payer database comprises different information than the compliant database.
